(19) United States
(12) Patent Application Publication
(10) Pub. No.: US 2013/0059655 A1
(43) Pub. Date: Mar. 7, 2013

(54) GAME AUTHENTICATION METHOD FOR GAMING MACHINES AND GAME PLATFORM WITH AUTHENTICATION CAPABILITY

(71) Applicants: Bryan Wasicek, Austin, TX (US); Sherrod Segraves, Austin, TX (US); JP Cody, Austin, TX (US)

(72) Inventors: Bryan Wasicek, Austin, TX (US); Sherrod Segraves, Austin, TX (US); JP Cody, Austin, TX (US)

(73) Assignee: Multimedia Games, Inc.

(21) Appl. No.: 13/603,251

(22) Filed: Sep. 4, 2012

Related U.S. Application Data
(60) Provisional application No. 61/531,601, filed on Sep. 6, 2011.

(51) Int. Cl. A63F 13/08

(52) U.S. Cl. 463/29

(57) ABSTRACT

A gaming machine is configured to calculate hash values for both game loader software and game software. The game loader software is executed to load game software into random access memory at the gaming machine, and game software is executed at the gaming machine to provide a wagering game or a portion thereof. The calculated hash values are compared to hash values produced from a known authentic version of the game software and of the game loader software. The game software is allowed to load and present a wagering game if both of these comparisons are true, that is, if both comparisons show that the calculated and pre-calculated values are equal.

### CROSS-REFERENCE TO RELATED APPLICATION

The Applicants claim the benefit, under 35 U.S.C. §119(e), of U.S. Provisional Patent Application No. 61/531,601 filed Sep. 6, 2011, and entitled “Game Authentication Method for Gaming Machines and Game Platform with Authentication Capability.” The entire content of this provisional application is incorporated herein by this reference.

### BACKGROUND OF THE INVENTION

1. Field of the Invention

This invention relates to wagering games, gaming machines, gaming systems, and associated methods. More particularly, the invention relates to software and data authentication in gaming machines and gaming systems.

2. Description of the Related Art

Various techniques have been used to provide authentication of software and data loaded into a gaming machine preparatory to the conduct of a wagering game at or through the gaming machine. Such authentication is helpful not only to ensure proper operation of games at the gaming machine, but also to ensure that the software or data is not tampered with in an effort to change the operation of the game. There continues to be a need for secure and thorough methods of authenticating software and data which may be loaded into a processor at a gaming machine.

### SUMMARY OF THE INVENTION

A gaming machine embodying principles of the present invention may include a cabinet having associated therewith a user interface, a game credit device, and a display device. A processor may be positioned within the cabinet and may be in operative communication with the user interface and display device. The gaming machine may also include random access memory for the processor and also first, second, and third read-only memory devices, each read-only memory device readable by the processor. At startup of the gaming machine, the processor is adapted to load and execute BIOS software and operating system (OS) software stored at the gaming machine. The first read-only memory device stores game software executable by the processor to conduct at least a portion of a wagering game. The second read-only memory device stores an encrypted hash value for the game software stored in the first read-only memory device. The third read-only memory device stores game loader software and an encrypted hash value for the game loader software.

The game loader software is executable by the processor to calculate a hash value for the game software, decrypt the encrypted hash value for the game software, and compare the calculated hash value for the game software with the decrypted hash value for the game software. The game loader software is also executable to calculate a hash value for the game loader software, decrypt the encrypted hash value for the game loader software, and compare the calculated hash value for the game loader software with the decrypted hash value for the game loader software. In some forms of the present invention, the game loader software is further executable to enable the gaming machine for play of the game provided by the game software if the comparison of the calculated and decrypted hash values for the game software are equal and if the comparison of the calculated and decrypted hash values for the game loader software are equal. However, the game loader software is executable to prevent play of the game provided by the game software if either comparison shows that the compared values are not equal.

These and other advantages and features of the invention will be apparent from the following description of illustrative embodiments considered along with the accompanying drawings.

### BRIEF DESCRIPTION OF THE DRAWINGS

FIG. 1 is a view in perspective of an example gaming machine in which embodiments of the present invention may be implemented.

FIG. 2 comprises a block diagram of the example gaming machine shown in FIG. 1.

FIG. 3 comprises a block diagram of an example gaming network which may employ one or more gaming machines embodying principles of the present invention.

FIG. 4 is a flow chart showing an example gaming machine start up process in accordance with one or more embodiments of the present invention.

FIG. 5 is a flow chart showing a hash algorithm selection process in accordance with some embodiments of the present invention.

### DESCRIPTION OF ILLUSTRATIVE EMBODIMENTS

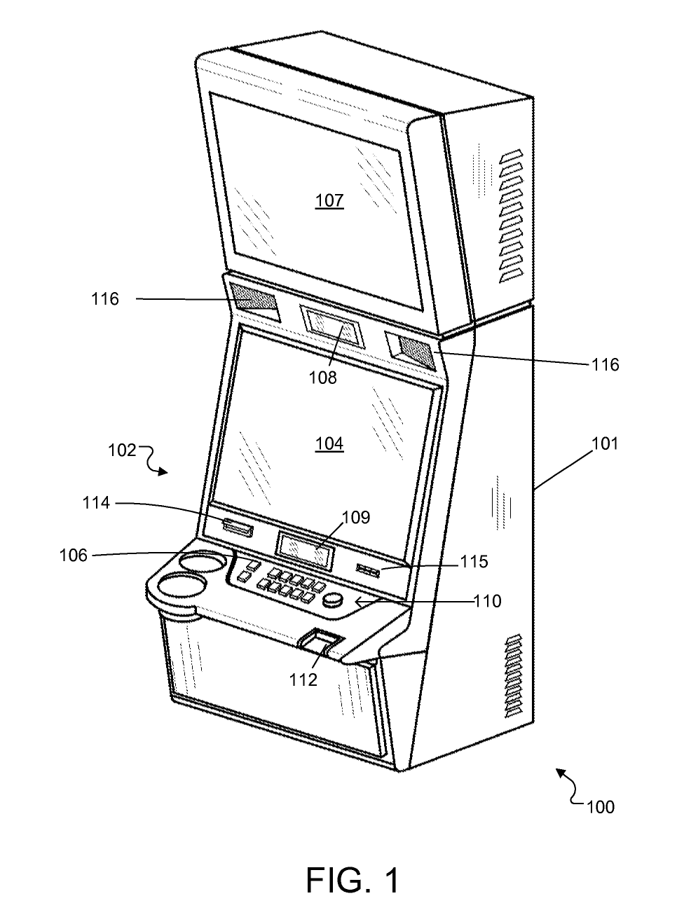

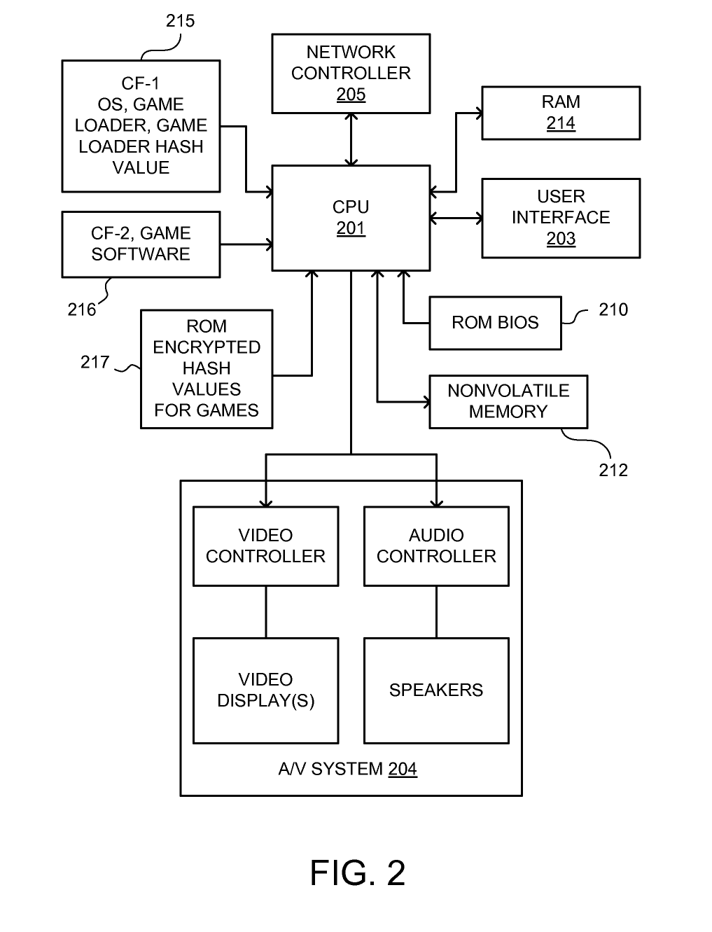

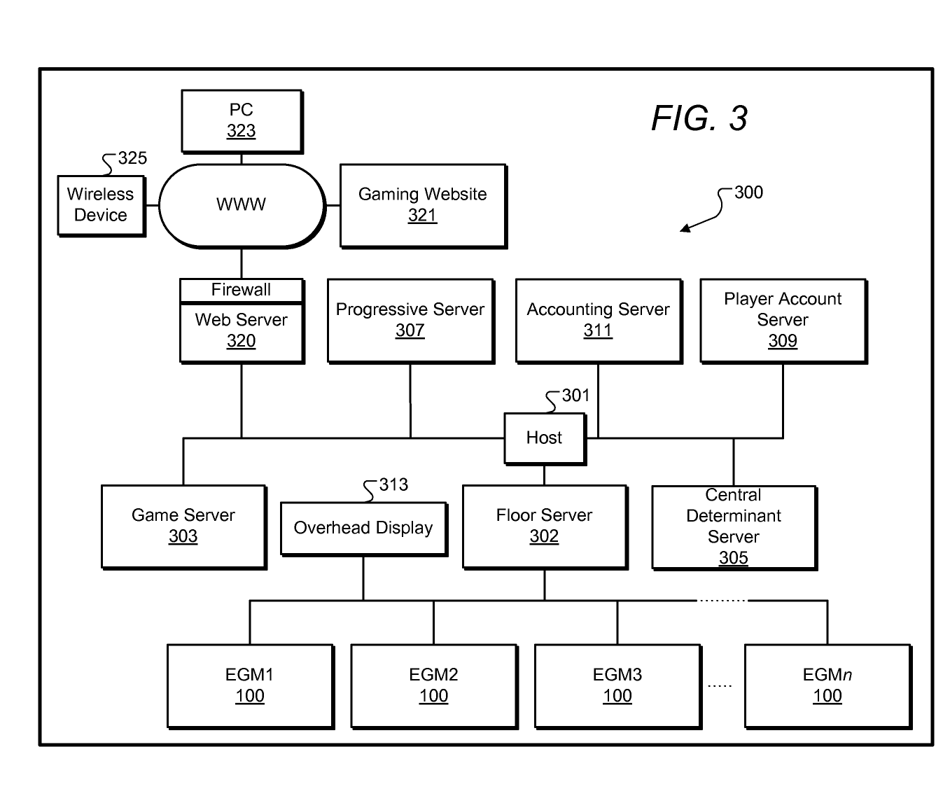

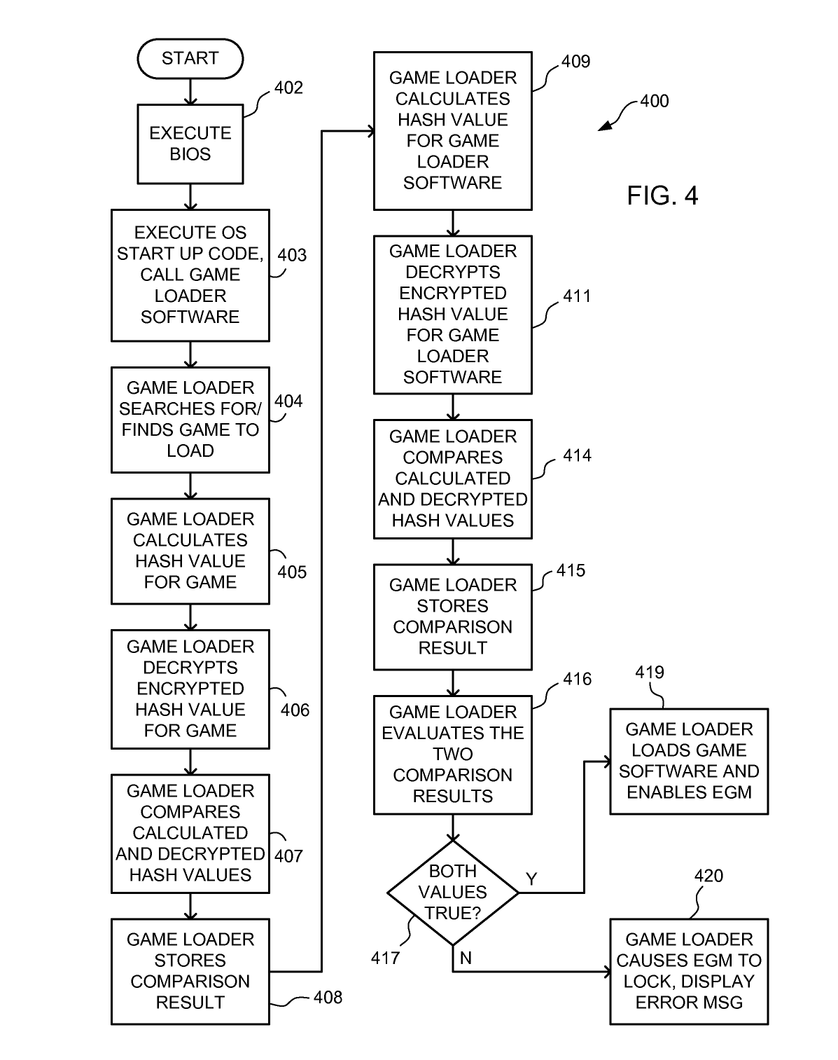

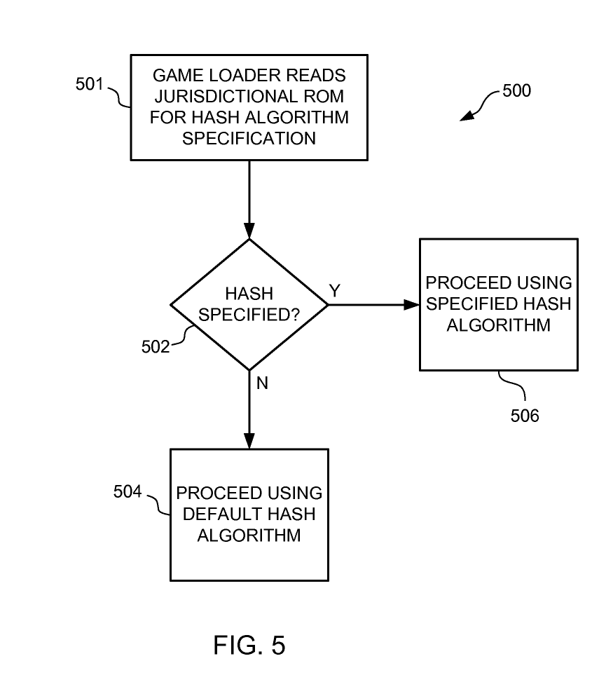

In the following description, FIG. 1 will be used to describe an example gaming machine 100 which may implement embodiments of the present authentication system, while FIG. 2 will be used to describe further technical details of gaming machine 100. The block diagram of FIG. 3 will be used to describe an example gaming system in which authentication systems according to the present invention may be applied. Methods according to the present invention will then be described with reference to the flow charts of FIGS. 4 and 5.

Referring to FIG. 1, gaming machine 100 includes a cabinet 101 having a front side generally shown at reference numeral 102. A primary video display device 104 is mounted in a central portion of the front surface 102, with a button panel 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. Each display device referenced herein may include any suitable display device including a cathode ray tube, liquid crystal display, plasma display, LED display, or any other type of display device currently known or that may be developed in the future.

The gaming machine 100 illustrated for purposes of example in FIG. 1 also includes a number of mechanical control buttons 110 mounted on button panel 106. These control buttons 110 may allow a player to select a bet level, select pay lines, select a type of game or game feature, and actually start a play in a primary game. Other forms of gaming machines through which the invention may be implemented may include switches, joysticks, or other mechanical input devices, and/or virtual buttons and other controls implemented on a suitable touchscreen video display. For example, primary video display device 104 in gaming machine 100 provides a convenient display device for implementing touchscreen controls in addition to or in lieu of mechanical controls. The player interface devices which receive player inputs to initiate the play of a game through the gaming machine, such as controls to select a wager amount for a given play and control to actually start a given play, may be referred to generally as a player input system.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Numerous other types of player interface devices may be included in gaming machines that may be used according to the present invention.

A gaming machine which may be used to implement embodiments of the present invention may also include a sound system to provide an audio output to enhance the user's playing experience. For example, illustrated gaming machine 100 includes speakers 116 which may be driven by a suitable audio amplifier to provide a desired audio output at the gaming machine.

As shown in the diagrammatic representation of FIG. 2, gaming machine 100 includes a CPU or game processor 201 operatively connected to a user interface 203, an audiovisual (A/V) system 204, and a network controller 205. Game processor 201 operates under the control of game software to receive inputs through user interface 203 and to present a wagering game at the gaming machine. The wagering game and any associated audio output are presented to the player through audiovisual system 204. In particular, one or more video displays included in audiovisual system 204 may be driven by a video controller to provide graphics to present a wagering game at the gaming machine. The video displays indicated in FIG. 2 may correspond to one or more of the video display devices shown in FIG. 1. For example, primary display 104 in FIG. 1 provides a convenient display device for presenting game graphics to a player at gaming machine 100. In addition to the video output provided by audiovisual system 204, the audio controller shown in FIG. 2 may drive speakers to produce various sounds in coordination with the displayed graphics. The speakers shown in FIG. 2 may correspond to speakers 116 in FIG. 1.

Network controller 205 shown in FIG. 2 provides an interface for network communications to and from devices in a network in which gaming machine 100 is included. Various types of network communications which may be effected through network controller 205 will be described below in connection with the example network shown in FIG. 3.

CPU 201 executes BIOS (basic input/output system) software read from ROM BIOS 210 and also executes game software which has been loaded into random access memory (RAM) 214. This game software may be stored in nonvolatile memory 212 and loaded into RAM 214 only when it is necessary for CPU 201 to execute the game or portions thereof. Nonvolatile memory 212 may comprise any suitable mass storage device such as a magnetic media hard drive or a solid-state hard drive.

Authentication methods according to the present invention control the loading of game software into random access memory 214 to ensure that the game software operates correctly and has not been subject to tampering. In order to accomplish this authentication, the illustrated gaming machine 100 includes three additional read-only memory (ROM) devices which, in this example, include a first read-only solid-state memory device 215, a second read-only solid-state memory device 216, and a third read-only memory device 217. The content and functions of the memory devices 215, 216, and 217 will be described below in connection with the flow chart shown in FIG. 4. It should be appreciated that the ROM devices 215, 216, and 217 may comprise any suitable types of ROM devices. One preferred arrangement employs a respective read-only Compact Flash memory device for each device 215, 216, and 217.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 201, 203, 204, 205, 210, and 212 shown in FIG. 2 are elements commonly associated with a personal computer. These elements may be mounted on a standard personal computer chassis and housed in a standard personal computer housing which is itself mounted in cabinet 101 shown in FIG. 1. Alternatively, the various electronic components may be mounted on one or more circuit boards housed within cabinet 101 without a separate enclosure such as those found in personal computers. The additional read-only memory devices 215, 216, and 217, may each be mounted in a suitable socket or other physical interface to enable game processor 201 to access data and/or programs stored on those devices. Those familiar with data processing systems and the various data processing elements shown in FIG. 2 will appreciate that many variations on this illustrated structure may be used within the scope of the present invention. For example, a touchscreen controller may be included in the system for implementing touchscreen controls on one or more display devices included in audio visual system 204. Such a touchscreen controller may, along with devices included in user interface 203, communicate with game processor 201 using serial communications. Thus the system may include a suitable serial interface such as a USB, IEEE 1394, RS-232, and/or RS-485 controller operatively connected to the game processor. The various serial devices would then be connected via suitable cables or other connections to the respective serial controller. It will also be appreciated that a system such as that shown in FIG. 2 may include one or more buses facilitating communications between game processor 201 and the various devices. For example, the video controller (graphics processor) and audio controller may both be connected on an expansion bus such as a PCIe bus which is operatively connected to game processor 201. The connection paths between game processor 201 and the various components shown in FIG. 2 are shown merely to indicate that the various components are connected in some fashion for communication with the game processor. FIG. 2 is not intended to limit the invention to any particular bus architecture.

It will also be appreciated that the functions provided by the video controller/graphics processor shown in FIG. 2, and the functions provided by the audio controller, may alternatively be performed directly by game processor 201. The invention is not limited to any particular arrangement of processing devices for controlling the video display devices and audio devices included with gaming machine 100. Also, a gaming machine implementing the present invention is not limited to any particular number of video display devices or other types of display devices.

Furthermore, rather than, or in addition to, video displays for presenting a wagering game, a gaming machine within the scope of the present invention may include one or more mechanical devices such as mechanical reels which are controlled through game processor 201 to display a wagering game. For example, mechanical reel-type games may include a number of reels which are mounted to be rotated about an axis and to display peripherally arranged reel symbols. The reels may be driven by stepper motors controlled by game processor 201, and the stepper motors may be controlled through game processor via serial communications or otherwise. The present authentication invention is not limited to gaming machines having any particular display arrangement. Rather, the present invention applies to any processor controlled gaming machine which may currently exist or which may be developed in the future.

In the illustrated gaming machine 100, game processor 201 executes software which ultimately controls game play and related functions including the receipt of player inputs and the presentation of the graphic symbols to display game outcomes and features. Game processor 201 also executes software related to communications handled through network controller 205, and software related to various peripheral devices. Game processor 201 may also execute software to perform accounting functions associated with play of the games offered through the gaming machine. In particular, game processor 201 may control one or more credit devices such as credit meters which track credits available to the player, credits won, credits wagered, and various other credit totals. The values maintained by these meters may be displayed through dedicated displays included in the gaming machine or through video display devices such as primary display device 104 for example.

Referring now to FIG. 3, a networked gaming system 300 associated with one or more gaming facilities may include one or more networked gaming machines 100 (EGMs) connected in the network by suitable network cable or wirelessly. The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the information to networked gaming machines 100 providing lottery and bingo-based wagering games to players.

Progressive server 307 may accumulate progressive awards by receiving defined amounts, such as a percentage of the wagers from eligible gaming devices or by receiving funding from marketing or casino funds. Progressive server 307 may also provide progressive awards to winning gaming devices in response to a progressive event. Such a progressive event may comprise, for example, a progressive jackpot game outcome or other triggering event such as a random or pseudo-random win determination at a networked gaming device or server. Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Networked gaming machines 100 (EGM1-EGMn) and one or more overhead displays 313 may be operatively connected so that the overhead display or displays may mirror or replay the content of one or more displays of gaming machines 100. For example, the primary display content for a given gaming machine 100 may be stored under control of a display controller or game processor 201 of the given gaming machine and transmitted through network controller 205 as shown in FIG. 2 to a controller (not shown) associated with the overhead display(s) 313. In the event gaming machines 100 have cameras installed, the respective player's video images may be displayed on overhead display 313 along with the content of the player's gaming machine display.

Example gaming network 300 also includes a gaming website 321 which may be hosted through web server 320 and may be accessible by players via the Internet. One or more games may be displayed as described herein and played by a player through a personal computer 323 or handheld wireless device 325 (for example, a smartphone, personal digital assistant (PDA), tablet computer, etc.). To enter website 321, a player may log in with a user name that may, for example, be associated with the player's account information stored on player account server 309. Once logged on to website 321, the player may play various games on the website. Also, website 321 may allow the player to make various personalizing selections and save the information so it is available for use during the player's next gaming session at a casino establishment having the gaming machines 100.

FIG. 4 illustrates a process 400 for authenticating game software at an electronic gaming machine such as gaming machine 100 described above. As will be apparent from the following disclosure, the authentication process 400 includes not only a verification of the game software, but also the software responsible for loading the game software.

The process 400 shown in FIG. 4 may be performed by game processor 201 shown in FIG. 2 each time the gaming machine is initially turned on and made ready for presenting a wagering game. When the gaming machine is first turned on, the game processor 201 first executes BIOS software as indicated at process block 402 to identify certain peripheral devices and ready the processor for executing operating system (OS) software. The processor next executes operating system software and calls game loader software as indicated at process block 403. In one example implementation, the operating system software and game loader software are stored on a first read-only memory device such as device 215 in FIG. 2.

Once the game loader software is loaded into random access memory (such as RAM 214 in FIG. 2) and executed, the game loader software searches for and locates a specified game to be loaded into random access memory at the gaming machine. This process is shown at process block 404 in FIG. 4. Once the game is located, the game loader software calculates a hash value for the game as indicated at process block 405. This calculation may be performed using a hash algorithm defined as a default hash logarithm or a hash algorithm specified by the game loader software. It is also possible that the hash algorithm will be specified on a jurisdictional or other basis as will be described below in connection with FIG. 5. Regardless of which hash algorithm is used in the process according to process block 405, the result of the calculation is a hash value for the game which is designated to be loaded for execution at the gaming machine.

Once the game loader software has executed to cause the hash value to be calculated as indicated at process block 405, the game loader software also executes to decrypt an encrypted hash value for the game as indicated at process block 406. In one implementation of the invention, the encrypted hash value is read from a read-only memory device such as device 217 shown in FIG. 2. The calculated hash value for the game software calculated at process block 405 and the hash value for the game software decrypted at process block 406 are compared as indicated at process block 407, and the comparison result is then stored as indicated at process block 408.

As indicated at process block 409, the game loader software also causes a hash value for the game loader software itself to be calculated. That is, the game loader software which was loaded into RAM at process block 403 in FIG. 4, uses an appropriate hash algorithm to calculate a hash value for the game loader software in the storage location from which the game loader software was called. In the example gaming machine shown in FIG. 2, this storage location is the read-only memory device 215. In addition to calculating the hash value for the game loader software, the game loader software also causes an encrypted hash value for the game loader software to be decrypted as indicated at process block 411. In the example gaming machine implementation shown in FIG. 2, the encrypted hash value for the game loader software is stored in the read-only memory device 215 which also stores the game loader software itself and the operating system software. Ultimately, the game loader software is executed to compare the calculated and decrypted hash values for the game loader software as indicated at process block 414 and causes the comparison result to be stored as indicated at process block 415.

Once the comparison results produced as indicated at process blocks 408 and 415 are available, the game loader software evaluates the two comparison results as indicated at process block 416. If both values are true, that is, if the calculated and decrypted hash values for the game software are equal and if the calculated and decrypted hash values for the game loader software are equal, then the process branches from decision box 417 to process block 419 and the game loader software causes the game software to be loaded into RAM at the gaming machine and enables the gaming machine for play of the loaded game. However, if the result of decision box 417 is negative, that is, if either one of the stored comparison values are false then the game loader software causes the gaming machine to lock and display an error message as indicated at process block 420.

It will be appreciated that processes according to the invention may perform the process steps indicated in FIG. 4 in any one of several different orders to produce the desired result of either blocking the gaming machine from operation or enabling the gaming machine. For example, the gaming machine processor may calculate the hash value for the game loader software before calculating the hash value for the game software specified to be loaded.

In the example process illustrated in FIG. 4, it is the game loader software which is executed to make the various calculations, decryptions, and comparisons to authenticate the game software and either enable the gaming machine or lock the gaming machine. Thus authentication program code according to the present invention is encompassed within the game loader software. Other implementations within the scope of the present invention may perform the authentication steps indicated in FIG. 4 with authentication program code separate from the game loader software.

Other implementations of an authentication process according to the present invention may be employed outside of gaming machine startup. For example, some gaming machines may store, or have access to, different sets of game program code, each set being executable to provide a different wagering game. In this case, the gaming machine that has been executing first game software may be instructed through a suitable arrangement to discontinue the first game and begin executing a second game. Although the gaming machine processor will not execute BIOS software in this case as indicated at process block 402 in FIG. 4, the gaming machine processor may execute game loader software for finding the new game software to load as indicated at process block 404 in FIG. 4, and perform the other steps shown at process blocks 405, 406, 407, 408, 409, 411, 414, 415, and 416. In this case of a change from one game to another, the game loader software causes the second game software to be loaded into RAM at the gaming machine and may enable the gaming machine to conduct the second game similar to the step at process block 419 in FIG. 4. Where either one of the comparison results is not true, the game loader software may cause the gaming machine to lock and display an error message similar to the step at process block 420.

As indicated above in connection with process blocks 405 and 409, there may be some variation in the particular hash algorithm used to calculate the hash values for the game software and the game loader software. It is also possible for different hash algorithms to be used for these two calculations. In some cases, the hash algorithm which must be used for authentication may be specified on a jurisdictional basis. The flowchart shown in FIG. 5 shows a process which identifies a particular hash algorithm to be used in a hash calculation according to the present invention. As indicated in FIG. 5 at process block 501, a jurisdictional read-only memory device included at the gaming machine, which may be read-only memory device 217 for example (or perhaps a different read-only memory device not shown in the example system of FIG. 2), stores a specification for a given hash algorithm to be used in one or more of the hash calculations. Thus process block 501 of FIG. 5 shows that the game loader software reads the jurisdictional read-only memory device to locate any hash algorithm specification. If the jurisdictional read-only memory device specifies a hash algorithm as indicated by a positive result at decision box 502, the game loader software is executed to use the specified hash algorithm as indicated at process block 506. However, if the jurisdictional read-only memory device does not specify any hash algorithm to be used for any of the authentication processes, the game loader software proceeds with the process shown in FIG. 4 using a default hash algorithm.

It should be noted that the present authentication system is not limited to any particular hash algorithm (or “algorithms” if different ones are used for the game software and game loader software). Rather, any hash function may be used and modified as desired by using cryptographic salt with the algorithm. However, it will be appreciated that the hash algorithm and any salt used to produce the hash values encrypted and stored in memory device 217 must be the same as that used by the game loader software for the calculation indicated at process block 405 in FIG. 4. Similarly, the hash algorithm and any salt used to produce the hash values encrypted and stored in memory device 217 must be the same as that used by the game loader software for the calculation indicated at process block 409 in FIG. 4.

Referring generally to the forgoing description, as used herein the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

1. A gaming machine including:
(a) a cabinet having associated therewith a user interface, a game credit device, and a display device;
(b) a processor positioned within the cabinet and in operative communication with the user interface and display device, the processor adapted to, upon startup thereof, execute BIOS software and OS software stored at the gaming machine;
(c) one or more random access memory devices positioned within the cabinet and in operative communication with the processor;
(d) a first read-only memory device positioned within the cabinet and readable by the processor, the first read-only memory device storing game software executable by the processor to conduct at least a portion of a wagering game;
(e) a second read-only memory device positioned within the cabinet and readable by the processor, the second read-only memory device storing an encrypted hash value for the game software stored in the first read-only memory device;
(f) a third read-only memory device positioned within the cabinet and readable by the processor, the third read-only memory device storing game loader software and an encrypted hash value for the game loader software, the game loader software being executable to,
(i) calculate a hash value for the game software,
(ii) decrypt the encrypted hash value for the game software,
(iii) compare the calculated hash value for the game software with the decrypted hash value for the game software,
(iv) calculate a hash value for the game loader software,
(v) decrypt the encrypted hash value for the game loader software,
(vi) compare the calculated hash value for the game loader software with the decrypted hash value for the game loader software,
(vii) enable the gaming machine for play of the game provided by the game software if the comparison at (iii) shows that the compared values in that step are equal and if the comparison at (vi) shows that the compared values in that step are equal, and
(viii) prevent play of the game provided by the game software if either the comparison at (iii) shows that the compared values in that step are not equal or the comparison at (vi) shows that the compared values in that step are not equal, or if both comparisons show the compared values to be not equal.

2. The gaming machine of claim 1 wherein the game loader software reads the first read-only memory device to identify a hash algorithm specification stored in the first read-only memory device, and employs the specified hash algorithm to calculate the hash value for the game software and to calculate the hash value for the game loader software.

3. The gaming machine of claim 2 wherein the first read-only memory device is a jurisdictional memory device which is specific to a particular gaming jurisdiction.

4. A gaming system including:
(a) one or more gaming system servers;
(b) a number of gaming machines operatively connected for network communications with at least one of the one or more gaming system servers;
(c) at least one of the gaming machines including a processor positioned within a cabinet of the gaming machine, the processor adapted to, upon startup thereof, execute BIOS software and OS software stored at the gaming machine;
(d) one or more random access memory devices positioned within the cabinet of the at least one of the gaming machines and in operative communication with the processor of that gaming machine;
(e) a first read-only memory device positioned within the cabinet of the at least one of the gaming machines and readable by the processor of the at least one of the gaming machines, the first read-only memory device storing game software executable by the processor of that gaming machine to conduct at least a portion of a wagering game;
(f) a second read-only memory device positioned within the cabinet of the at least one of the gaming machines and readable by the processor of that gaming machine, the second read-only memory device storing an encrypted hash value for the game software stored in the first read-only memory device;
(g) a third read-only memory device positioned within the cabinet of the at least one of the gaming machines and readable by the processor of that gaming machine, the third read-only memory device storing game loader software and an encrypted hash value for the game loader software, the game loader software being executable to,
(i) calculate a hash value for the game software,
(ii) decrypt the encrypted hash value for the game software,
(iii) compare the calculated hash value for the game software with the decrypted hash value for the game software,
(iv) calculate a hash value for the game loader software,
(v) decrypt the encrypted hash value for the game loader software,
(vi) compare the calculated hash value for the game loader software with the decrypted hash value for the game loader software,
(vii) enable the respective gaming machine for play of the game provided by the game software if the comparison at (iii) shows that the compared values in that step are equal and if the comparison at (vi) shows that the compared values in that step are equal, and
(viii) prevent play of the game provided by the game software if either the comparison at (iii) shows that the compared values in that step are not equal or the comparison at (vi) shows that the compared values in that step are not equal, or if both comparisons show the compared values to be not equal.

5. The gaming system of claim 4 wherein the game loader software reads the first read-only memory device of the respective gaming machine to identify a hash algorithm specification stored in that first read-only memory device, and employs the specified hash algorithm to calculate the hash value for the game software and to calculate the hash value for the game loader software at that gaming machine.

6. The gaming system of claim 5 wherein the first read-only memory device of the respective gaming machine is a jurisdictional memory device which is specific to a particular gaming jurisdiction.

7. A method of operating a gaming machine having a gaming machine processor for executing game software to provide a wagering game through the gaming machine, the method including:
(a) under the control of game loader software, operating the processor of the gaming machine to identify game software to be loaded into random access memory at the gaming machine;
(b) with the processor of the gaming machine, calculating a hash value for the identified game software;
(c) with the processor of the gaming machine, reading an encrypted hash value for the identified game software from read-only memory at the gaming machine and decrypting the encrypted hash value for the identified game software;
(d) with the processor of the gaming machine, comparing the calculated hash value for the identified game software with the decrypted hash value for the identified game software;
(e) with the processor of the gaming machine, calculating a hash value for the game loader software;
(f) with the processor of the gaming machine, reading an encrypted hash value for the game loader software from read-only memory at the gaming machine and decrypting the encrypted hash value for the game loader software;
(g) with the processor for the gaming machine, comparing the calculated hash value for the game loader software with the decrypted hash value for the game loader software;
(h) enabling the gaming machine for play of the game provided by the identified game software if the comparison of the calculated hash value of the game software with the decrypted hash value of the game software shows that these compared values are equal and if the comparison of the calculated hash value of the game loader software with the decrypted hash value for the game loader software shows that these compared values are equal; and
(i) preventing play of the game provided by the identified game software if either the comparison of the calculated hash value for the identified game software and the decrypted hash value for the identified game software shows that these compared values are not equal or the comparison of the calculated hash value for the game loader software and the decrypted hash value for the game loader software shows that these compared values are not equal, or if both comparisons show that the compared values are not equal.

8. The method of claim 7 wherein the game loader software reads the first read-only memory device to identify a hash algorithm specification stored in the first read-only memory device, and employs the specified hash algorithm to calculate the hash value for at least one of the game software or the game loader software.

9. The method of claim 8 wherein the first read-only memory is a jurisdictional memory device which is specific to a particular gaming jurisdiction.

10. The method of claim 8 further including employing a default hash algorithm to calculate the hash value for the game loader software.
